(19) United States
(12) Patent Application Publication
(10) Pub. No.: US 2006/0203512 A1
(43) Pub. Date: Sep. 14, 2006

(54) Backlight module

(75) Inventors: Ya-Hua Ko, Shengang Township (TW); Hsin-Wu Lin, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/155,529

(22) Filed: Jun. 17, 2005

(30) Foreign Application Priority Data
Mar. 10, 2005 (TW) 94107268

(51) Int. Cl. G01D 11/28

(52) U.S. Cl. 362/609; 362/26; 362/27

(57) ABSTRACT

A backlight module includes a reflective plate and a light source. The reflective plate comprises a plurality of reflective regions, and the light source is disposed at a side of the reflective plate. Diffusivity of the reflective regions away from the light source is different from diffusivity of the reflective regions near the light source.

The application claims the benefit of Taiwan application Serial Mo. 94107268, filed Mar. 10, 2005, the subject matter of which is incorporated herein by reference.

### BACKGROUND

The present invention relates to a backlight module, and particularly to a backlight module having a reflective plate with portions of different diffusivity thereon.

Generally, a liquid crystal display (LCD) comprises a liquid crystal panel and a backlight module. Since the liquid crystal panel does not emit light itself, a light source providing sufficient brightness and uniform distribution is required to properly display images. As such, the backlight module serves as the light source for the LCD.

Backlight modules can be categorized into direct and edge structures, in which different optical films and plates are utilized. In direct backlight modules the light source is disposed directly in the cavity of the backlight module, thus occupying a relatively larger volume thereof. In edge backlight modules, the light source is disposed at a side of the backlight module to reduce volume thereof, and a light guide plate guides the light toward the liquid crystal panel.

FIG. 1 is an exploded view showing an LCD 100 with a conventional edge backlight module. In FIG. 1, the LCD 100 comprises a liquid crystal panel 180, a frame 190, and a conventional edge backlight module disposed in the frame 190. The conventional edge backlight module comprises a lamp as the light source 110, a reflective plate 120, and a light guide plate 130. A plurality of optical films 140, such as protective diffusion plates, prism films, brightness enhancement films and inner diffusion plates, are generally used in the backlight module. Further, a light source reflector 115 can be disposed at the outside of the light source 110 to prevent light from scattering outward from the backlight module. The light guide plate 130 and the optical films 140 can be alternatively disposed or removed, depending on particular requirement.

In FIG. 1, the light source 110 emits light toward the light guide plate 130. The light guide plate 130 guides the light toward the upper side of the backlight module, i.e., toward the liquid crystal panel 180, so as to enhance brightness of the liquid crystal display 100 and brightness distribution on the liquid crystal panel 180. The reflective plate 120 reflects the light scattering back to the light guide plate 130 to enhance light usage. Alternatively, in the backlight module without the light guide plate 130, the light source 110 emits light toward the reflective plate 120 directly, and the reflective plate 120 reflects the light toward the liquid crystal panel 180.

Generally, brightness distribution of an edge backlight module is determined by the microstructure and size of the light guide plate. In a conventional edge backlight module, however, the light guide plate may adversely reduce the light usage and increases a significant weight for the backlight module when the size of the backlight module is large. In this case, it is difficult to modulate the reflective plate 120 made of a single material according to the microstructure and size thereof. Thus, deterioration of brightness distribution may occur.

Further, arrangement of the light source 110 of the edge backlight module affects the brightness thereof. For example, the light source 110 can be disposed at a single side of the reflective plate 120, as shown in FIG. 2A.

Alternatively, two light sources 110 can be disposed at both side portions of the reflective plate 120, as shown in FIG. 2B. The light source 110 can be disposed at the periphery portions of the reflective plate 120 as shown in FIG. 2C. In this case, it is difficult to modulate the reflective plate 120 made of a single material according to the arrangement of the light source 110. Thus, deterioration of brightness distribution may also occur.

### SUMMARY

One object of the present invention is to provide a backlight module, which comprises a reflective plate and a light source. The reflective plate comprises a plurality of reflective regions. The light source is disposed at a side of the reflective plate. Diffusivity of the reflective regions away from the light source is different from diffusivity of the reflective regions near the light source.

Another object of the present invention is to provide a backlight module, which comprises a reflective plate and two light sources. The reflective plate comprises first reflective regions on both side portions thereof and a second reflective region on a central portion thereof. The two light sources are disposed at both of the side portions of the reflective plate and adjacent to the first reflective regions. Diffusivity of the second reflective region is different from diffusivity of the first reflective regions.

Still another object of the present invention is to provide a backlight module, which comprises a reflective plate and at least one light source. The reflective plate comprises a first reflective region on a peripheral portion thereof and a second reflective region on a central portion thereof. The light source is disposed at the peripheral portion of the reflective plate and adjacent to the first reflective region. Diffusivity of the second reflective region is different from diffusivity of the first reflective region.

Various embodiments of the present invention are given in the following detailed description with reference to the accompanying drawings.

### DESCRIPTION OF THE DRAWINGS

The present invention can be more fully understood by reading the subsequent detailed description in conjunction with the examples and references made to the accompanying drawings, wherein:

FIG. 1 is a dissembled side view of a conventional edge backlight module;

FIG. 2A is a schematic view of a conventional edge backlight module with the light source disposed at one side of the reflective plate thereof;

FIG. 2B is a schematic view of a conventional edge backlight module with the light source disposed at both sides of the reflective plate thereof;

FIG. 2C is a schematic view of a conventional edge backlight module with the light source disposed at the peripheral portion of the reflective plate thereof;

FIG. 3 is a perspective view of an embodiment of a backlight module according to the present invention;

FIG. 4A is a schematic view of another embodiment of the backlight module according to the present invention;

FIG. 4B is a schematic view of another embodiment of the backlight module according to the present invention; and

FIG. 4C is a schematic view of still another embodiment of the backlight module according to the present invention.

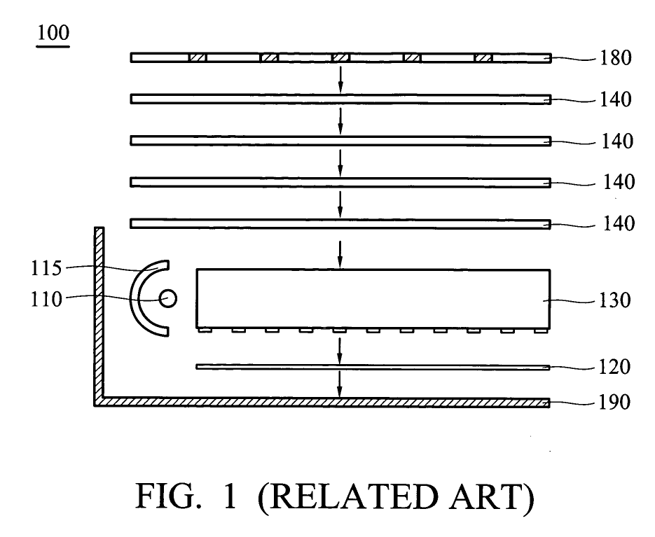

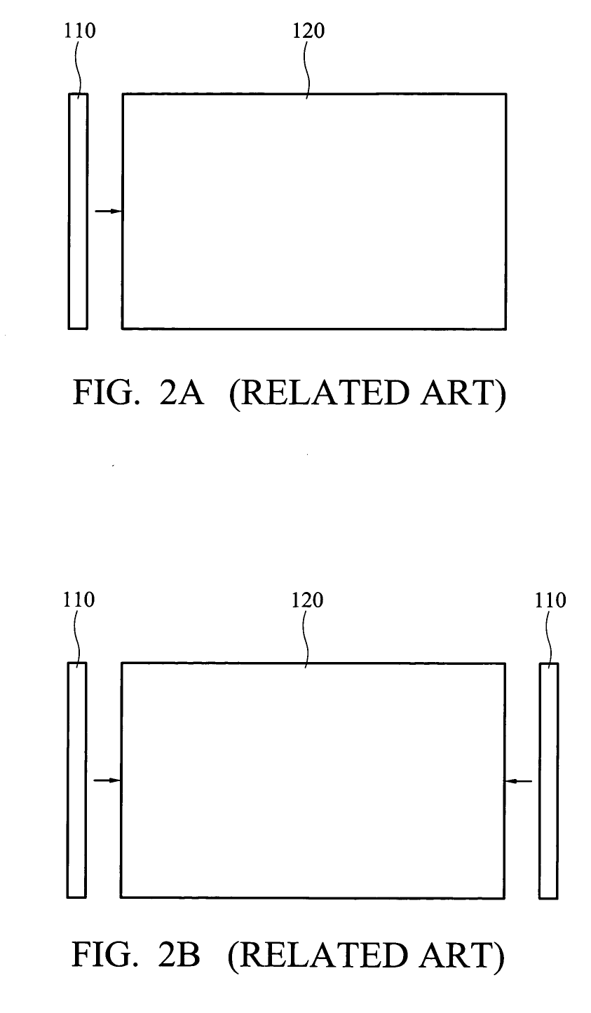

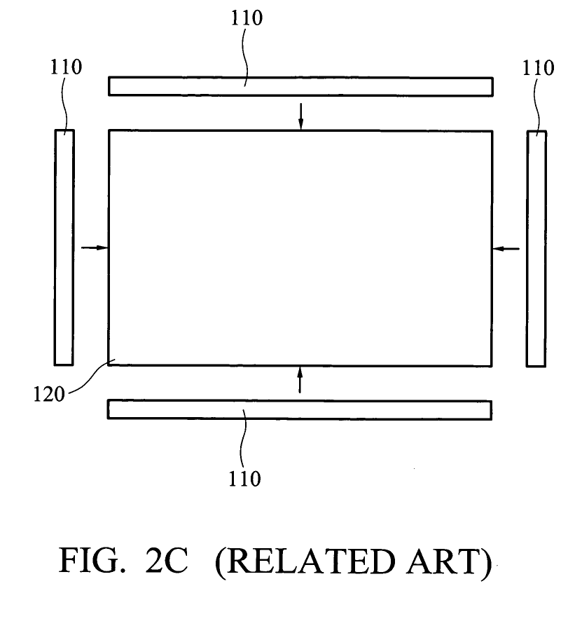

### DETAILED DESCRIPTION

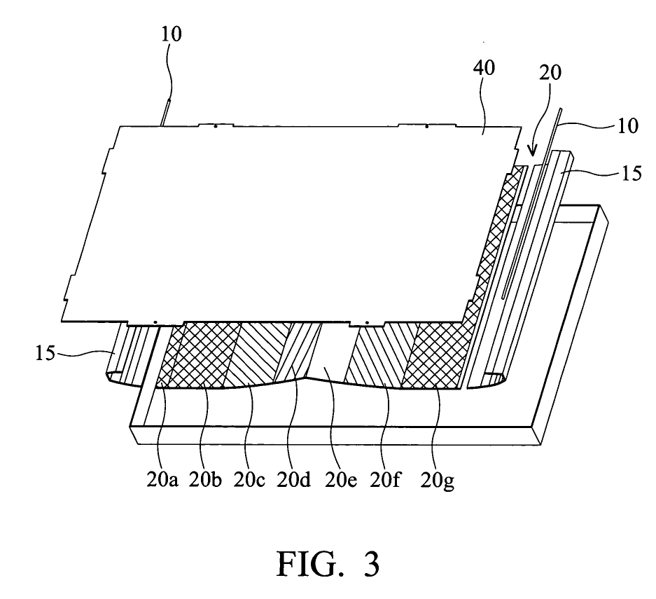

FIG. 3 shows an embodiment of a backlight module according to the present invention. In the backlight module, as shown in FIG. 3, light sources 10 are disposed at both sides of a reflective plate 20. The backlight module comprises the light sources 10, the reflective plate 20, a plurality of optical films 40 and a light source reflector 15. There is no light guide plate provided. The light sources 10 are disposed at both sides of the reflective plate 20. The reflective plate 20 comprises a plurality of reflective regions 20a, 20b, 20c, 20d, 20e, 20f, and 20g. Light emitted from the light sources 10 is reflected by the reflective plate 20 toward the direction of the optical films 40. Among the reflective regions 20a, 20b, 20c, 20d, 20e, 20f, and 20g, the middle reflective region 20d is away from the light sources 10, and the reflective regions 20a and 20g are near the light sources 10. Diffusivities of the reflective regions 20a, 20b, 20c, 20d, 20e, 20f, and 20g are set to be different in order to enhance the brightness distribution. Diffusivity of the reflective regions 20d, which is away from the light sources 10, is the largest; that is, surface of the reflective region 20d can be a diffusing surface. Diffusivity of the reflective regions 20a and 20g, which is near the light sources 10, is the smallest; that is, surfaces of the reflective region 20a and 20g can be reflective surfaces. Diffusivity of the reflective regions therebetween can be modulated according to the position, in which diffusivity of the reflective regions away from the light sources 10 is larger than diffusivity of the reflective regions near the light sources 10.

In manufacturing the reflective plate 20, the surfaces of the reflective regions 20a, 20b, 20c, 20d, 20e, 20f, and 20g can be made of different materials. Alternatively, diffusion particles with different surface densities can be employed on the surfaces of the reflective regions to differentiate the diffusivity thereof. For example, the surface densities of the diffusion particles of the reflective regions away from the light source can be higher than the surface densities of the diffusion particles of the reflective regions near the light source.

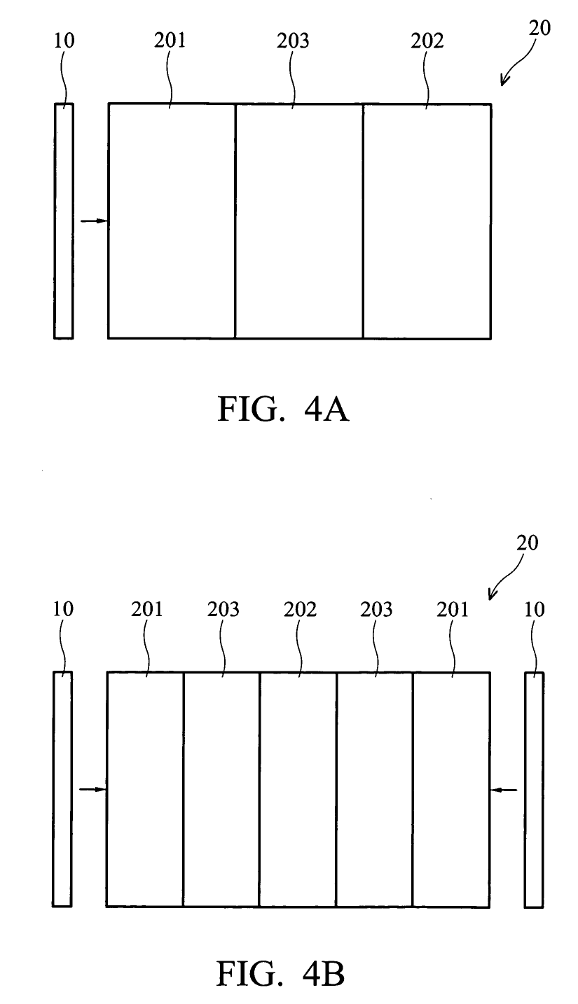

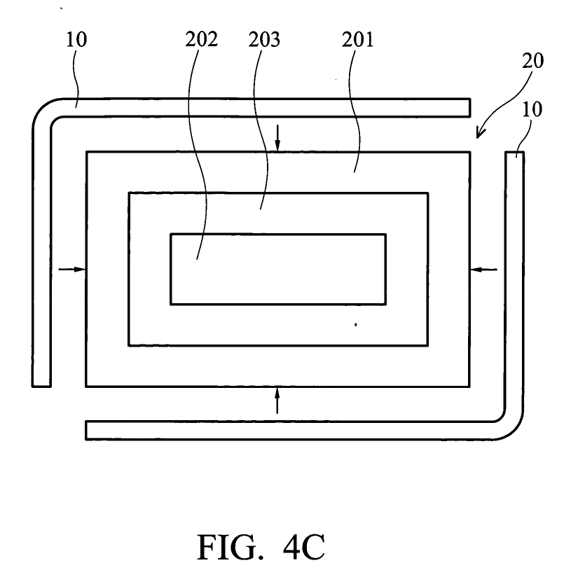

Further, the reflective regions on the reflective plate 20 can be determined according to arrangement of the light source 10. Several embodiments of the reflective plate 20 are hereinafter described with respect to FIG. 4A, FIG. 4B and FIG. 4C.

In FIG. 4A, the light source 10 is disposed at one side of the reflective plate 20. In this case, the reflective regions on the reflective plate 20 can be a first reflective region 201 adjacent to the light source 10, a second reflective region 202 away from the light source 10, and a third reflective region 203 between the first reflective region 201 and the second reflective region 202. The first reflective region 201 has a first diffusivity, the second reflective region 202 has a second diffusivity, and the third reflective region 203 has a third diffusivity. Since the second reflective region 202 is away from the light source 10, the second diffusivity is larger than the third diffusivity of the third reflective region 203. Further, the third diffusivity is larger than the first diffusivity of the first reflective region 201. Thus, the brightness distribution of the backlight module can be enhanced.

In FIG. 4B, the light sources 10 are disposed at both side portions of the reflective plate 20. In this case, the reflective regions on the reflective plate 20 can be two first reflective regions 201 on both side portions of the reflective plate 20, a second reflective region 202 on a central portion of the reflective plate 20, and a plurality of third reflective regions 203 between the first reflective region 201 and the second reflective region 202. The first reflective regions 201 are adjacent to the light sources 10, and the second reflective region 202 is away from the light sources 10. The first reflective regions 201 have a first diffusivity, the second reflective region 202 has a second diffusivity, and the third reflective regions 203 have a third diffusivity. Since the second reflective region 202 is away from the light sources 10, the second diffusivity is larger than the third diffusivity of the third reflective regions 203. Further, the third diffusivity is larger than the first diffusivity of the first reflective regions 201. Thus, the brightness distribution of the backlight module can be enhanced.

In FIG. 4C, the light source 10 is disposed at a peripheral portion (which includes all of the edge portions) of the reflective plate 20. In this case, the reflective regions on the reflective plate 20 can be a first reflective region 201 on the peripheral portion of the reflective plate 20, a second reflective region 202 on a central portion of the reflective plate 20, and a third reflective region 203 between the first reflective region 201 and the second reflective region 202. The first reflective region 201 is adjacent to the light source 10, and the second reflective region 202 is away from the light source 10. The first reflective region 201 has a first diffusivity, the second reflective region 202 has a second diffusivity, and the third reflective region 203 has a third diffusivity. Since the second reflective region 202 is away from the light source 10, the second diffusivity is larger than the third diffusivity of the third reflective region 203. Further, the third diffusivity is larger than the first diffusivity of the first reflective region 201. Thus, the brightness distribution of the backlight module can be enhanced.

It should be noted that in the above-mentioned embodiments of FIG. 4A to FIG. 4C, the reflective regions on the reflective plate 20 are categorized as three groups, i.e. the first, second and third reflective regions. In practical application, however, the reflective regions can be categorized as any number of groups, depending on the structure and size of the backlight module.

Further, the light source 10 in the embodiments can be cold cathode fluorescent lamps (CCFLs), light emitting diodes (LEDs), or any other type of light emitting devices.

While the present invention has been described by way of example and in terms of preferred embodiments, it is to be understood that the present invention is not limited thereto. Rather, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module, comprising:
a reflective plate comprising a plurality of reflective regions; and
a light source disposed at a side of the reflective plate;
wherein a diffusivity of the reflective regions away from the light source is different from a diffusivity of the reflective regions near the light source.

2. The backlight module as claimed in claim 1, wherein the diffusivity of the reflective regions away from the light source is greater than the diffusivity of the reflective regions near the light source.

3. The backlight module as claimed in claim 1, wherein surfaces of the reflective regions comprise different materials.

4. The backlight module as claimed in claim 1, wherein surfaces of the reflective regions away from the light source are diffusing surfaces, and surfaces of the reflective regions near the light source are reflective surfaces.

5. The backlight module as claimed in claim 1, wherein the reflective regions comprise diffusion particles on surfaces thereof, the diffusion particles on different surfaces having different surface densities.

6. The backlight module as claimed in claim 5, wherein the surface densities of the diffusion particles of the reflective regions away from the light source is greater than the surface densities of the diffusion particles of the reflective regions near the light source.

7. The backlight module as claimed in claim 1, wherein the light source comprises a cold cathode fluorescent lamp (CCFL) or a light emitting diode (LED).

8. The backlight module as claimed in claim 1, wherein the reflective plate comprises:
a first reflective region adjacent to the light source and having a first diffusivity;
a second reflective region away from the light source and having a second diffusivity; and
a third reflective region between the first reflective region and the second reflective region and having a third diffusivity;
wherein the second diffusivity is greater than the third diffusivity, and the third diffusivity is greater than the first diffusivity.

9. A backlight module, comprising:
a reflective plate comprising first reflective regions on both side portions thereof and a second reflective region on a central portion thereof, wherein diffusivity of the second reflective region is different from diffusivity of the first reflective regions; and
two light sources disposed at both of the side portions of the reflective plate and adjacent to the first reflective regions.

10. The backlight module as claimed in claim 9, wherein the diffusivity of the second reflective region is greater than the diffusivity of the first reflective regions.

11. The backlight module as claimed in claim 9, wherein the first reflective regions and the second reflective region comprise diffusion particles on the surface thereof, wherein a surface density of the diffusion particles of the second reflective region is different from a surface densities of the diffusion particles of the first reflective regions.

12. The backlight module as claimed in claim 11, wherein the surface density of the diffusion particles of the second reflective region is greater than the surface densities of the diffusion particles of the first reflective regions.

13. The backlight module as claimed in claim 9, wherein surfaces of the first reflective regions and a surface of the second reflective region are made of different materials.

14. The backlight module as claimed in claim 9, wherein a surface of the second reflective region is a diffusing surface, and surfaces of the first reflective regions are reflective surfaces.

15. The backlight module as claimed in claim 9, wherein the light source comprises a cold cathode fluorescent lamp (CCFL) or a light emitting diode (LED).

16. The backlight module as claimed in claim 9, wherein the reflective plate further comprises a third reflective region between the first reflective regions and the second reflective region, wherein a diffusivity of the third reflective region is larger than the diffusivity of the first reflective regions and is smaller than the diffusivity of the second reflective region.

17. A backlight module, comprising:
a reflective plate comprising a first reflective region on a peripheral portion thereof and a second reflective region on a central portion thereof, wherein a diffusivity of the second reflective region is different from a diffusivity of the first reflective region; and
at least one light source disposed at the peripheral portion of the reflective plate and adjacent to the first reflective region.

18. The backlight module as claimed in claim 17, wherein the diffusivity of the second reflective region is greater than the diffusivity of the first reflective region.

19. The backlight module as claimed in claim 17, wherein the reflective plate further comprises a third reflective region between the first reflective region and the second reflective region, wherein a diffusivity of the third reflective region is larger than the diffusivity of the first reflective region and is smaller than the diffusivity of the second reflective region.

20. The backlight module as claimed in claim 17, wherein a surface of the first reflective region and a surface of the second reflective region comprise different materials.

21. The backlight module as claimed in claim 17, wherein a surface of the second reflective region is a diffusing surface, and a surface of the first reflective regions is a reflective surface.

22. The backlight module as claimed in claim 17, wherein the first reflective region and the second reflective region comprise diffusion particles on the surface thereof, wherein a surface density of the diffusion particles of the second reflective region is different from a surface density of the diffusion particles of the first reflective region.

23. The backlight module as claimed in claim 22, wherein the surface density of the diffusion particles of the second reflective region is greater than the surface density of the diffusion particles of the first reflective region.

24. The backlight module as claimed in claim 17, wherein the light source comprises a cold cathode fluorescent lamp (CCFL) or a light emitting diode (LED).
